(19) United States
(12) Patent Application Publication
(10) Pub. No.: US 2012/0082601 A1
(43) Pub. Date: Apr. 5, 2012

(54) HONEYCOMB REACTOR OR HEAT EXCHANGER MIXER

(75) Inventor: James Scott Sutherland, Corning, NY (US)

(73) Assignee: Corning Incorporated, Corning, NY (US)

(21) Appl. No.: 13/322,960

(22) PCT Filed: May 28, 2010
(86) PCT No.: PCT/US2010/036646

§ 371 Date: Nov. 29, 2011

Related U.S. Application Data
(60) Provisional application No. 61/182,757, filed on May 31, 2009.

(51) Int. Cl. B01J 19/00; F28F 1/00

(52) U.S. Cl. 422/630; 165/177; 422/129

(57) ABSTRACT

A honeycomb reactor or heat exchanger (12) includes a honeycomb (20) having a plurality of cells (22, 24) extending in parallel along a common direction from a first end (14) to a second end (16) thereof, with the cells being divided by walls (23), the honeycomb (20) having one or more first passages (28) formed within a first plurality of cells (24) of the honeycomb (20), the first passages (28) extending laterally from cell to cell within the honeycomb (20) and being accessible via ports or holes (30) in or through a side (18) of the honeycomb (20). The honeycomb (20) also as a plurality of second passages (29) formed within a second plurality of cells (22) within the honeycomb (20), the second passages (29) each extending from first cell openings (31a) at the first end (14) of the honeycomb (20) to second cell openings (31b) at the second end (16) of the honeycomb (20). The second passages (29) each describe at least one S-bend beginning at the first end (14) of the monolith (20) and extending to the second end (16) and there bending back to the first end (14) and there bending back again to the second end (16).

This application claims the benefit of priority of U.S. Provisional Application Ser. No. 61/182,757 filed on May 31, 2009.

### BACKGROUND

The present disclosure relates to honeycomb reactors or heat exchangers, and particularly to such honeycomb reactors or heat exchangers providing enhanced mixing of fluids passing therethrough, and to methods for forming such devices.

### SUMMARY

According to one embodiment of the present disclosure, a honeycomb reactor or heat exchanger 12 includes a honeycomb 20 having a plurality of cells 22, 24 extending in parallel along a common direction from a first end 14 to a second end 16 thereof, with the cells being divided by walls 23, the honeycomb 20 having one or more first passages 28 formed within a first plurality of cells 24 of the honeycomb 20, the first passages 28 extending laterally from cell to cell within the honeycomb 20 and being accessible via ports or holes 30 in or through a side 18 of the honeycomb 20. The honeycomb 20 also as a plurality of second passages 29 formed within a second plurality of cells 22 within the honeycomb 20, the second passages 29 each extending from first cell openings 31a at the first end 14 of the honeycomb 20 to second cell openings 31b at the second end 16 of the honeycomb 20. The second passages 29 each describe at least one S-bend beginning at the first end 14 of the monolith 20 and extending to the second end 16 and there bending back to the first end 14 and there bending back again to the second end 16.

Other features and advantages of the present invention will be apparent from the figures and following description and claims.

### BRIEF DESCRIPTION OF THE FIGURES

FIGS. 1 and 2 are cross-sectional representations of second passages according to two alternative embodiments of the present disclosure;

FIG. 3 is a honeycomb reactor or heat exchanger according to an embodiment of the present disclosure;

FIGS. 4 and 5 are additional alternative embodiments of second passages of the present disclosure;

FIG. 6 is a schematic perspective view of a multistage reactor of the present disclosure;

FIG. 7 shows a perspective view of a reactor according to and that may be utilized or modified according to the methods of the present disclosure;

FIGS. 8 and 9 illustrate cross sections showing alternate internal structure of the reactor of FIG. 7; and

FIGS. 10-12 show plan views of alternate configurations of the reactor of FIG. 7.

### DETAILED DESCRIPTION

Various techniques for fabricating low-cost continuous flow chemical reactors or heat exchangers based on honeycomb monolith technology have been presented by the present inventor and/or his associates, such as those disclosed in PCT Publication No. WO2008121390, for example, assigned to the present assignee.

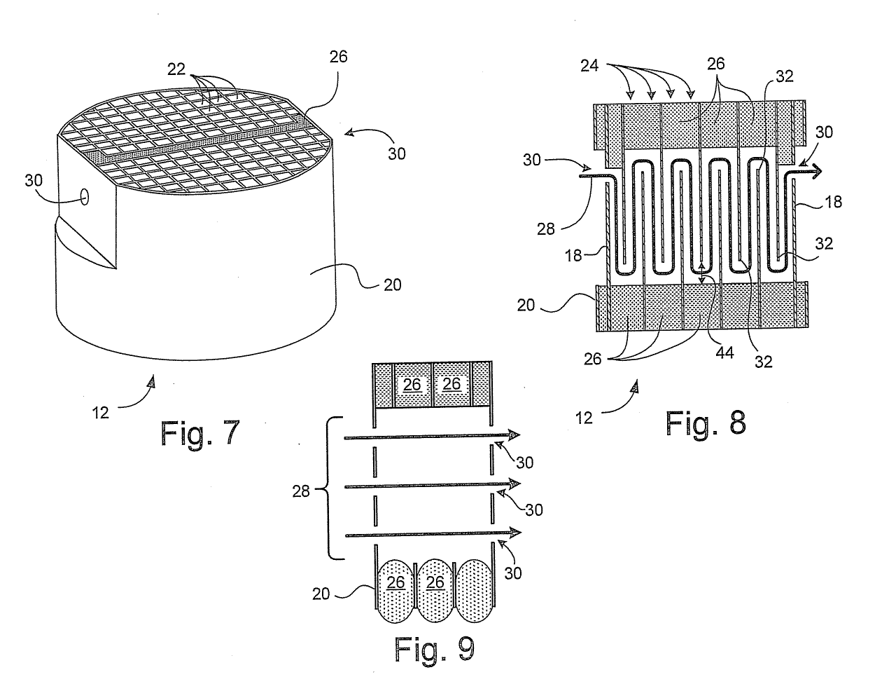

As shown herein in the perspective view of FIG. 7 and in the partial cross section of FIG. 8, in reactors 12 or heat exchangers 12 of the type generally utilized in the context of the present disclosure, a fluid flows along one or more first paths or passages 28 defined within a set of typically millimeter-scale channels 24 in a honeycomb monolith 20, which channels 24 are closed, generally at both ends, by individual plugs or plugging material 26. Selected walls 32 between channels 24 are lowered as seen in the cross-section of FIG. 8 (where every other wall in the cross-section is lowered).

A gap 44 is left between plugs 26 or continuous plugging material 26 and the top/bottom of the lowered walls 32. This can allow for a long, relatively large volume serpentine first passage 28 to be formed in the honeycomb monolith 20 as seen in FIG. 8.

The first passage 28 may be accessed via access ports or holes 30 in the sides of the honeycomb monolith 20. Typically, heat exchange fluid is flowed parallel to the extrusion direction through the many open millimeter-scale channels 22.

If the lowered walls 32 are lowered nearly to the respective far end of the body 20 by means of deep plunge machining, a high-aspect ratio first passage 28 can be produced, which may be accessed by from multiple ports 30, as shown in the cross-section of FIG. 9. Variations between the two extremes of FIGS. 8 and 9 may also be used, such as a serpentine passage that follows more than one cell of the honeycomb monolith at a time, in parallel. Such passages are disclosed in PCT Publication No. WO2008121390, mentioned above.

Plugs 26 or continuous plugging material 26 can take various forms, including sintered plugs or plugging material 26 typically assuming a shape somewhat like that shown at the bottom of FIG. 9, or other forms, including epoxy or other polymer material and other materials that result in more or less square plugs or plugging material 26 as shown at the top of FIG. 9.

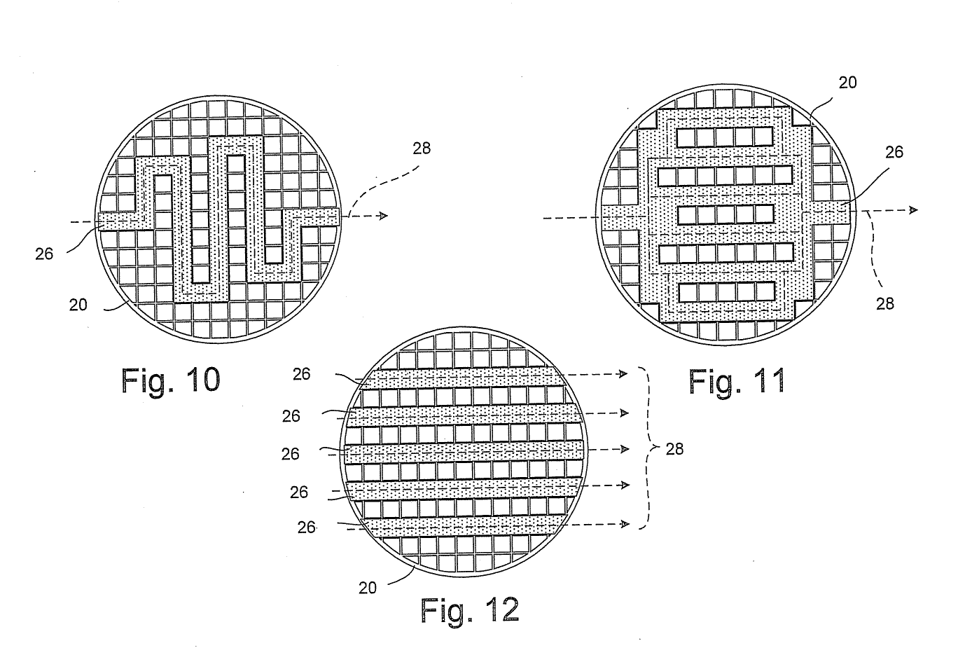

The shape of the one or more first paths or passages 28 in the plane perpendicular to the direction of the cells of the honeycomb monolith 20 may take various forms, as shown in the plan views of FIGS. 10-12. As shown in FIG. 10 and as an alternative to a straight line shape as shown in FIG. 7, the one or more first paths or passages 28 may have a serpentine shape in the plane perpendicular to the cells of the honeycomb monolith 20. As an additional alternative, a branching shape may be used as shown in FIG. 11, in which a first passage 28 divides within the extruded structure 20 into many sub-passages, then re-joins before exiting the structure 20. As another additional alternative, multiple first passages 28 may be defined through the honeycomb monolith 20 as shown in FIG. 12.

As noted above, typically, heat exchange fluid is flowed parallel to the extrusion direction through the many open millimeter-scale channels 22. But there are instances in which reactant fluid or reactant-containing fluid may beneficially be flowed in short paths like those of the open channels 22 of FIG. 7. Particularly where high flow rates with high surface area exposure and low pressure drop are desired, the extreme parallelism achievable in the channels 22 is desirable, and the one or more first passages may be used for thermal exchange. Where a high rate of thermal exchange is desired, high aspect ratio channels as in FIG. 9 may be applied in a configuration like that of FIG. 12.

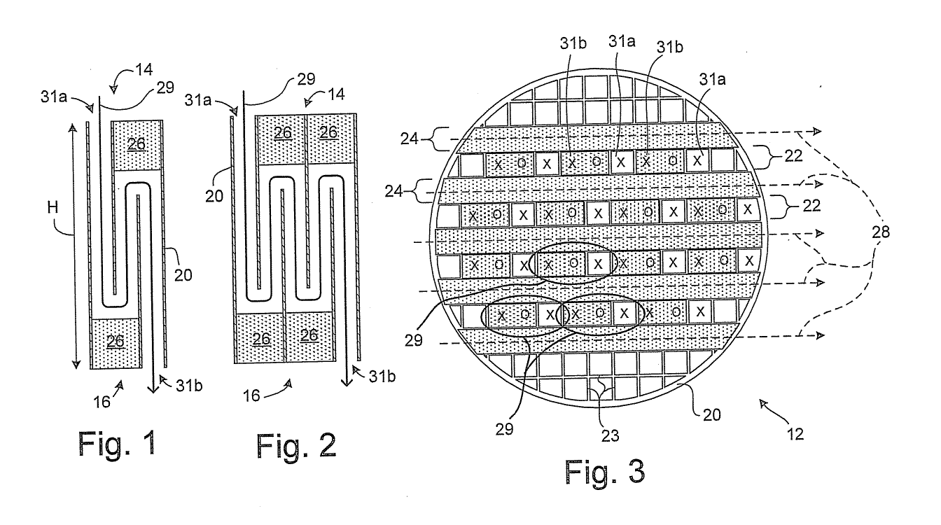

The present disclosure adds the possibility of providing mixing within this high throughput, high surface area processing environment. Specifically, a honeycomb reactor or heat exchanger 12 for providing enhanced mixing of fluids includes may be understood with reference to the plan view of a reactor 12 within a honeycomb 20 as shown in FIG. 3, with reference to FIGS. 1 and 2. The honeycomb 20 includes a plurality of cells 22, 24 extending in parallel along a common direction from a first end 14 to a second end 16 thereof, with the cells divided by walls 23.

The reactor 12 includes one or more first passages 28 formed within a first plurality of cells 24 of the honeycomb 20 and extending laterally from cell to cell within the honeycomb 20. The one or more first passages 28 are accessible via ports or holes 30 in or through a side 18 of the honeycomb 20, as shown in FIGS. 7-9.

The reactor 12 further includes a plurality of second passages 29 formed within a second plurality of cells 22 within the honeycomb 20. Two different embodiments of second passages 29 are shown in cross-sectional view in FIGS. 1 and 2, with the second passage 29 of FIG. 1 having a single S-bend and the second passage 29 of FIG. 2 having one and one-half S-bends therein. The type of second passage 29 shown in FIG. 1 corresponds to the type of second passages 29 in the reactor 12 of FIG. 3

The second passages 29 each extend from first cell openings 31a at the first end 14 of the honeycomb 20 to second cell openings 31b at the second end 16 of the honeycomb 20. According to the present disclosure for reactors of the type disclosed herein, the second passages 29 each describe at least one S-bend beginning at the first end 14 of the monolith 20 and extending to the second end 16 and there bending back to the first end 14 and there bending back again to the second end 16, as with the second passage 29 of FIG. 1 and the second passages 29 of the reactor 12 of FIG. 3.

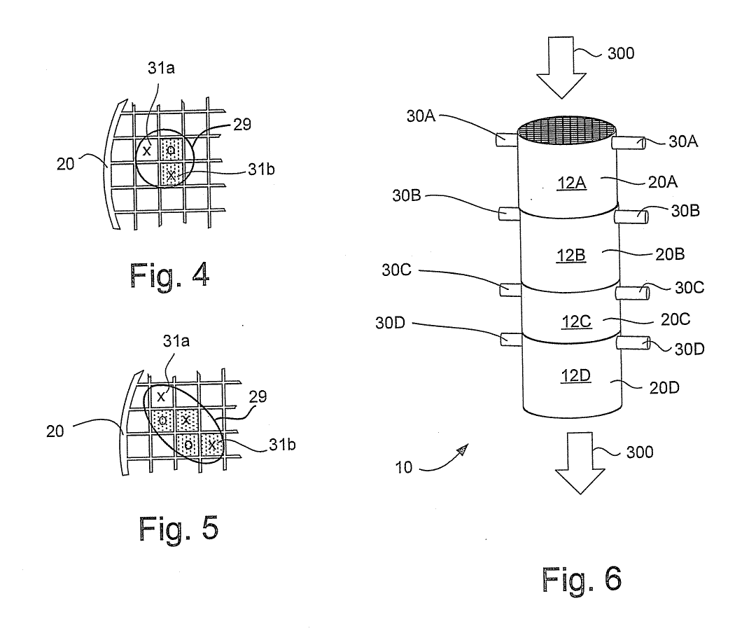

Second passages having higher numbers of S-bends may also be used, such as two or more, for example. Further, the second passages 29 need not, although they may, always be in a single respective plane. Neither of the second passages 29 shown in plan view in FIGS. 4 and 5 lie in a single respective plane, for example.

For many applications, it is desirable that the first cell openings 31a are distributed across the first end 14 of the honeycomb 20 of the reactor 12 in a two-dimensional distribution, as shown in FIG. 3.

The honeycomb 20 desirably comprises glass, glass-ceramic, or ceramic, but other materials may also be employed as desired.

Reactors according to the present disclosure may be beneficially used in more than one mode. As one mode, a reactant or reactant-containing fluid may be flowed in the one or more first passages 28 while a heat exchanging fluid is flowed in the second passages 29. As a second mode, a reactant or reactant-containing fluid may be flowed in the second passages 29 while a heat exchanging fluid is flowed in the one or more first passages 28. As a third mode, a first reactant or reactant-containing fluid may be flowed in the one or more first passages 28 while a second reactant or reactant-containing fluid is flowed in the second passages 29.

The reactors 12 of the present disclosure may also be beneficially employed in a multistage reactor 10 as shown in schematic perspective view in FIG. 6. the multistage reactor 10 includes a plurality of reactors 12A-12D of the type according to the present disclosure, arranged in an order such that a fluid 300 flowing out from the second passages 29 of at least one of the plurality of reactors 12A-12C flows directly into the second passages 29 of the next of the plurality of reactors 12B-D. Desirably, the number of S-bends of the second passages 29 varies from at least one of the plurality of reactors 12A-12C to the next 12B-12D, and the height H of the plurality of reactors 12A-12D may also vary from at least one of the plurality of reactors 12A-12C to the next 12B-12D. This allows for flexible customization of the heat exchange and mixing needs of a reaction process within the fluid 300.

Not as a limiting features, but as one potential benefit, the methods and devices of the present disclosure can provide for almost any desired degree of mixing within an easily manufactured, very high flow parallel channel (the second passages 29). By utilizing high flow rates and or by restricting the height H of the honeycombs 20, relatively fast mixing can be achieved.

Accordingly, the methods and/or devices disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

1. A honeycomb reactor or heat exchanger 12 for providing enhanced mixing of fluids passing therethrough, the reactor or heat exchanger comprising:
a honeycomb 20 having a plurality of cells 22, 24 extending in parallel along a common direction from a first end 14 to a second end 16 thereof, said cells divided by walls 23;
one or more first passages 28 formed within a first plurality of cells 24 of the honeycomb 20, and extending laterally from cell to cell within the honeycomb 20, the one or more first passages 28 being accessible via ports or holes 30 in or through a side 18 of the honeycomb 20;
a plurality of second passages 29 formed within a second plurality of cells 22 within the honeycomb 20, the second passages 29 each extending from first cell openings 31a at the first end 14 of the honeycomb 20 to second cell openings 31b at the second end 16 of the honeycomb 20;
wherein said second passages 29 each describe at least one S-bend beginning at the first end 14 of the monolith 20 and extending to the second end 16 and there bending back to the first end 14 and there bending back again to the second end 16.

2. The reactor or heat exchanger 12 according to claim 1 wherein said second passages 29 each describe one S-bend.

3. The reactor or heat exchanger 12 according to claim 1 wherein said second passages 29 each describe one and one-half S-bends.

4. The reactor or heat exchanger 12 according to claim 1 wherein said second passages 29 each describe two S-bends.

5. The reactor or heat exchanger 12 according to claim 1 wherein the first cell openings 31a are distributed across the first end 14 of the honeycomb 20 in a two-dimensional distribution.

6. The reactor or heat exchanger 12 according to claim 1 wherein said second passages 29 each lie in a respective plane parallel to the common direction of the cells 22, 24.

7. The reactor or heat exchanger 12 according to claim 1 wherein the honeycomb comprises glass, glass-ceramic, or ceramic.

8. A method of using a reactor or heat exchanger 12 according to claim 1 comprising flowing a reactant or reactant-containing fluid in the one or more first passages 28 while flowing a heat exchanging fluid in the second passages 29.

9. A method of using a reactor or heat exchanger 12 according to claim 1 comprising flowing a reactant or reactant-containing fluid in the second passages 29 while flowing a heat exchanging fluid in the one or more first passages 28.

10. A method of using the reactor or heat exchanger 12 according to claim 1 comprising flowing a first reactant or reactant-containing fluid in the one or more first passages 28 while flowing a second reactant or reactant-containing fluid in the second passages 29.

11. A multistage reactor 10 comprising a plurality of reactors 12A-12D according to claim 1 arranged in an order such that a fluid 300 flowing out from the second passages 29 of at least one of the plurality of reactors 12A-12C flows directly into the second passages 29 of the next of the plurality of reactors 12B-D.

12. The multistage reactor according to claim 11 wherein the number of S-bends of the second passages 29 varies from at least one of the plurality of reactors 12A-12C to the next 12B-12D.

13. The multistage reactor according to claim 11 wherein the height H of the plurality of reactors 12A-12D varies from at least one of the plurality of reactors 12A-12C to the next 12B-12D.
